(19) United States
(12) Patent Application Publication
(10) Pub. No.: US 2009/0046987 A1
(43) Pub. Date: Feb. 19, 2009

(54) SYSTEM FOR MANAGING RECORDING CONFLICTS OF MEDIA PROGRAMS

(75) Inventors: SCOTT WHITE, AUSTIN, TX (US); JAMES L. CANSLER, PFLUGERVILLE, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/838,699

(22) Filed: Aug. 14, 2007

(51) Int. Cl. H04N 5/91; H04N 7/18

(52) U.S. Cl. 386/83; 725/39

(57) ABSTRACT

A system that incorporates teachings of the present disclosure may include, for example, a media content processor having a controller to detect a recording conflict between a schedule change of a first media program and a scheduled recording of a second media program. Other embodiments are disclosed.

### FIELD OF THE DISCLOSURE

The present disclosure relates generally to media content and more specifically to a system for managing recording conflicts of media programs.

### BACKGROUND

With the advent of Video Cassette Recorders (VCRs) and most recently Digital Video Recorders (DVRs), many consumers can record media programs while in transit or while viewing other programs. It is not uncommon, however, that a previously scheduled media program is postponed or has a duration which exceeds its expected duration. Situations such as this arise when there are interruptions to programs (e.g., an emergency Presidential address), or in sports where the scheduled playing time is extended into overtime.

When a schedule change occurs, the recording schedules of one or more media programs can be affected. Some prior art systems can detect schedule changes and adapt a recording schedule of a media program to capture the extended play period. However, such systems do not address a recording conflict between media programs due to a schedule change.

### BRIEF DESCRIPTION OF THE DRAWINGS

FIG. 1 depicts an exemplary embodiment of a communication system;

FIG. 2 depicts an exemplary embodiment of a portal of the communication system;

FIG. 3 depicts an exemplary method operating in portions of the communication system; and

FIG. 4 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for detecting from an electronic programming guide a schedule change in a first media program being recorded, detecting a contention between the schedule change in the first media program and a scheduled recording of a second media program, transmitting a notice to a communication device of a subscriber, receiving a proposed resolution to said contention, and adjusting the recording schedule of at least one among the first and second media programs according to said proposed resolution.

In one embodiment of the present disclosure, a media content processor can have a controller to detect a recording conflict between a schedule change of a first media program and a scheduled recording of a second media program.

In one embodiment of the present disclosure, a computer-readable storage medium of a portal can have computer instructions for establishing communications with a media content processor and a communication device of a subscriber of the media content processor to resolve a recording conflict between a schedule change of a first media program and a scheduled recording by the media content processor of a second media program.

In one embodiment of the present disclosure, a communication device can have a controller to receive from a media content processor a notice associated with a recording conflict between a schedule change of a first media program and a scheduled recording by the media content processor of a second media program.

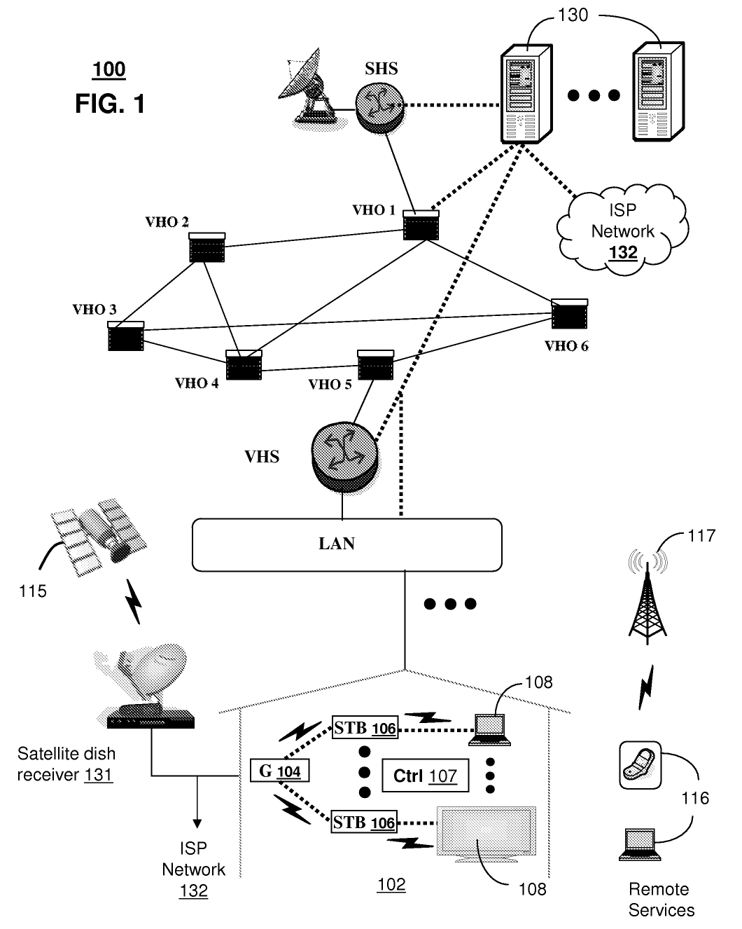

FIG. 1 depicts an exemplary embodiment of a communication system 100. The communication system 100 can represent an IPTV broadcast media system. In a typical IPTV infrastructure, there is at least one super head office server (SHS) which receives national media programs from satellite and/or media servers from service providers of multimedia broadcast channels. In the present context, media programs can represent audio only content, video only content, and/or combinations thereof. The SHS server forwards IP packets associated with the media content to video head servers (VHS) via a network of video head offices (VHO) according to a common multicast communication method.

The VHS then distributes multimedia broadcast programs to commercial and/or residential buildings 102 housing a gateway 104 (e.g., a residential gateway or RG). The gateway 104 distributes broadcast signals to media content processors 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media content processors 106 and subsystems of the IPTV media system for services such as video-on-demand (VoD).

The IPTV media system can be coupled to one or more computing devices 130 that can operate as a web or Internet server for providing portal services over an Internet Service Provider (ISP) network 132 to fixed media devices 108 or portable communication devices 116 by way of a wireless base station 117 such as in a cellular communication network operating with common protocols (GSM, CDMA, etc.).

The computing devices 130 can also include a presence system for monitoring activities and whereabouts of subscribers of the communication system 100. The presence system can for example detect that the subscriber is in transit with a portable communication device 116 by detecting a handover transition between base stations 117 and/or by receiving location coordinates from the portable communication device using a Global Positioning System (GPS) receiver incorporated therein. The presence system can also detect that the subscriber is utilizing a communication device 108 in building 102 based on network activity emanating from said communication device or being consumed thereby.

A satellite broadcast system can be used in place of the IPTV media system. In this embodiment, signals transmitted by a satellite 115 can be intercepted by a satellite dish receiver 131 coupled to building 102 which conveys media signals to the media content processors 106 by way of gateway 104. The media content processors 106 can be equipped with a broadband port to the ISP network 132. Although not shown, the communication system 100 can also be combined or replaced with analog or digital broadcast distributions systems such as cable systems. It would be apparent therefore to one of ordinary skill in the art that the present disclosure can be applied to any content media system.

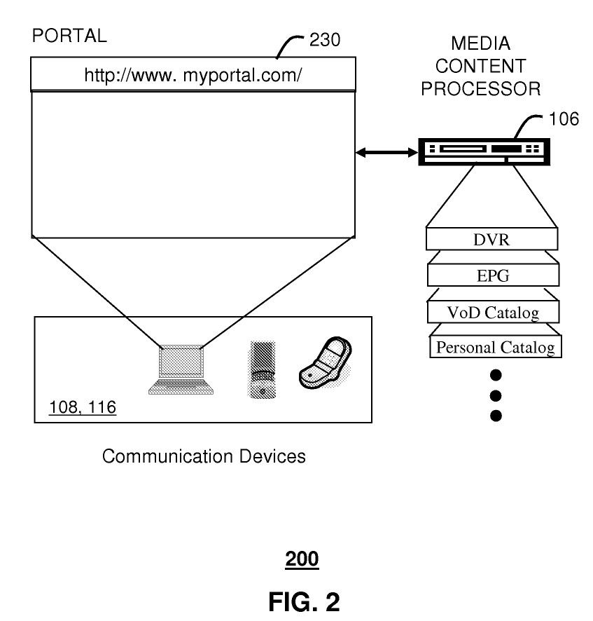

FIG. 2 depicts an exemplary embodiment of a portal 230 of the communication system 100. In FIG. 2, the portal 230 can be accessed by a URL with a common browser such as Microsoft's Internet Explorer using an Internet-capable fixed or portable communication device 108, 116. The portal 230 can be configured to access a media content processor 106 such as the STB of FIG. 1 and services managed thereby such as a Digital Video Recorder (DVR), an Electronic Programming Guide (EPG), Video on Demand (VoD) catalog, a personal catalog stored in the STB (e.g., personal videos, pictures, audio recordings, etc.), and so on by way of the gateway 104.

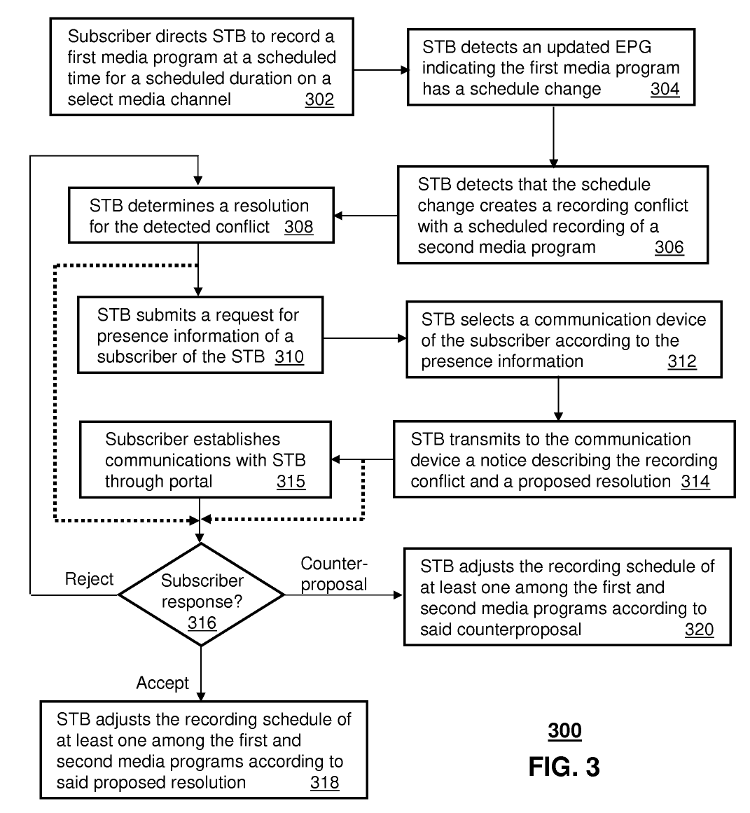

FIG. 3 depicts an exemplary method 300 operating in portions of the communication system 100. Method 300 begins with step 302 in which a subscriber directs the STB 106 to record a first media program at a scheduled time for a scheduled duration on a select media channel. The STB 106 in this illustration can have a built-in DVR function, or can direct a DVR device coupled thereto to record the first media program. The first media program can represent for example a baseball game scheduled at a time which the subscriber is unable to watch. In step 304, the STB 106 detects an updated electronic programming guide (EPG) indicating the first media program has a schedule change.

An updated EPG can be received by the STB 106 on a periodic basis from a network element of the IPTV media system. Alternatively, the STB 106 can poll the IPTV media system for updates to portions of the EPG. The portions polled can be for example media programs which the STB 106 is scheduled to record or is in the process of recording. By polling portions rather than downloading an entire EPG, the STB 106 can more efficiently and more promptly detect schedule changes. It should be noted that any method for detecting updates to an EPG can be applied by the STB 106 to achieve the objectives of the present disclosure.

An update to a media program in the present context can represent a change in the start or end time of the first media program. A change in the start time can occur when for example a previous media program experiences a delay which causes an overall delay in downstream media programs. A change in the end time can be detected while the first media program is being recorded and can arise when the media program has an extended play time (e.g., baseball game goes into extra innings).

Once a schedule change is detected, the STB 106 in step 306 can detect that there is a recording conflict between the first media program and a second media program which the subscriber had previously programmed the STB to record. The recording conflict can arise from the first media program overlapping in time with the start time of the second media program. When this occurs, the STB 106 can attempt in step 308 to determine a resolution for the detected conflict. To find a resolution, the STB can for example scan the EPG for alternative copies of the second media program. If one is available, the STB 106 can propose adjusting the start time and the media channel (if different) to record the alternative play time of the second media program.

Alternatively, the STB 106 can submit a request in step 308 to a network element of the communication system 100, such as for example a server that holds copies of scheduled media programs, to download in whole or in part the second media program on or after the new end time of the first media program. The second media program can be downloaded to the STB 106 by way of a broadband port of the STB connected to the ISP network 132. The communication system 100 can also charge the subscriber of the STB 106 a service fee for each media program requested in this manner. It should be noted that any resolution technique presently available or available in the future to mitigate recording conflicts of media programs can be applied to the present disclosure.

Once the STB 106 determines a resolution, it can proceed to step 310 where it submits a request to the presence system 130 for presence information of a subscriber of the STB. The presence information as noted earlier can be used by the STB to select in step 312 at least one among a plurality of communication devices 108 or 116 available to the subscriber with a predictable chance of reaching the subscriber. Once the selection is made, in step 314 the STB 106 transmits to the communication device 108 or 116 a notice describing the recording conflict and a proposed resolution for said conflict. Responsive to step 314, the subscriber can establish in step 315 communications with the portal 230 by invoking a common browser (e.g., Microsoft Windows Internet Explorer) that initiates communications with the portal. The portal 230 in response presents a login and password for the subscriber to enter account information unique to the subscriber. Once authenticated the subscriber can utilize the portal 230 to manage services of the STB 106 according to step 316.

In step 316, the subscriber can reject the proposed resolution, accept the proposed resolution or form a counterproposal by way of a graphical user interface (GUI) of the portal 230. If the subscriber rejects the resolution proposed by the STB 106, the STB can proceed to step 308 to determine another alternative resolution, present said alternative through the portal's 230 GUI, and await a response in step 316. These steps can be repeated until the subscriber accepts a resolution proposed by the STB 106, or the subscriber provides a counterproposal. Once the subscriber accepts a resolution proposed by the STB 106, the STB adjusts in step 318 the recording schedule of at least one among the first and second media programs according to the proposed resolution. If the subscriber provides a counterproposal, the STB 106 proceeds to step 320 where it adjusts the recording schedule of at least one among the first and second media programs according to the counterproposal.

In another embodiment, step 315 can be eliminated or automated in instances where the notice supplies one or more selectable Internet links in the form of selectable graphical user interface (GUI) elements such as GUI buttons: a GUI button for accepting the proposed resolution, a GUI button for rejecting the proposed resolution, and a GUI button to define a counterproposal. The Internet links can be defined by one or more Uniform Resource Identifiers (URIs) each represented by a Session Initiation Protocol URI (SIP URI) or a Uniform Resource locator (URL). Each URI in turn can include one or more instructions which can be used to direct the STB 106 to act on a proposed resolution from the STB or one defined by the subscriber.

For example, if the subscriber selects the GUI acceptance button by way of a user interface (navigation disk, joy stick or the like) of the communication device 108 or 116, said device can establish direct communications with the STB 106 according to the URI and direct the STB to adjust the recording schedule of at least one among the first and second media programs as in step 318 according to the embedded URI instructions. If the subscriber selects the GUI rejection button, the communication device 108 or 116 can establish communications with the STB 106 and directs it to propose another resolution by repeating method 300 from step 308. In the event the subscriber selects the GUI button to define a counterproposal, the communication device 108 or 116 can invoke a software client which presents a GUI interface that provides the subscriber the means to define a counterproposal. Once the counterproposal is crafted by the subscriber, the communication device 108 or 116 can establish communications with the STB 106 via the URI of the counterproposal GUI button and direct the STB according to step 320 based on the embedded URI instructions crafted with the software client.

In yet another embodiment, the selectable Internet links supplied in the notice can invoke an exchange with the portal 230 to manage the STB 106 according to the options given by step 316. In this instance the URI and embedded instructions of each GUI button (accept, reject or define a counterproposal) when selected by the subscriber establishes communications between the communication device 108 or 116 and the portal 230. The portal 230 then decodes the instructions embedded in the URI to direct the STB 106 according to the options of step 316. The status of transactions taking place by way of the portal 230 is presented to the communication device 108 or 116 by a GUI of said portal.

Upon reviewing the aforementioned embodiments, it would be evident to an artisan with ordinary skill in the art that said embodiments can be modified, reduced, or enhanced without departing from the scope and spirit of the claims described below. For example, the proposed resolution supplied in the notice can comprise not just one but a plurality of options to resolve the recording conflict. The communication device 108 or 116 can be programmed to present the options in a drop down menu or as text with selectable GUI buttons. Each GUI button can represent a URI with embedded instructions for directing the STB according to the option selected. Alternatively, the subscriber can log into the portal 230 and select the options from a GUI of the portal which in turn leads the portal to direct the STB 106 accordingly.

These are but a few examples of modifications that can be applied to the present disclosure without departing from the scope of the claims. Accordingly, the reader is directed to the claims section for a fuller understanding of the breadth and scope of the present disclosure.

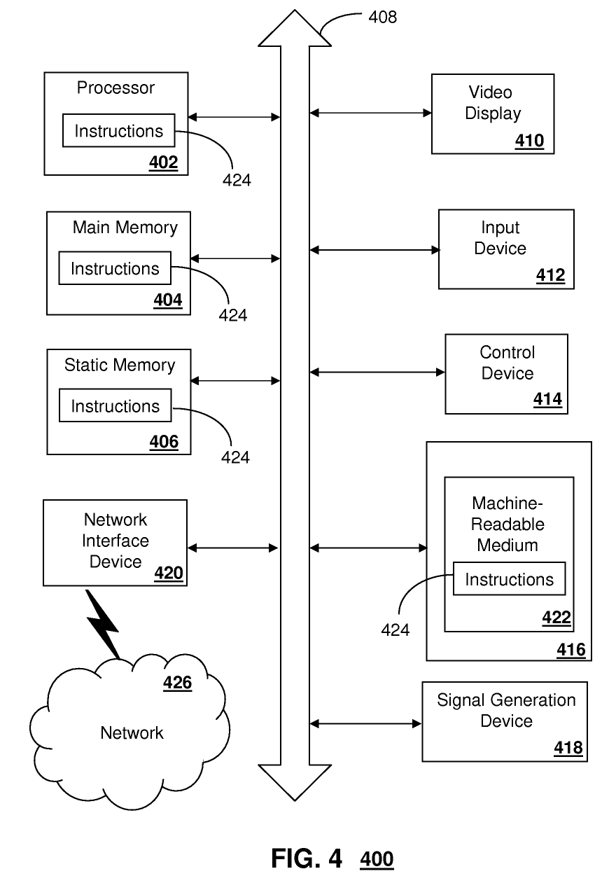

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
detecting from an electronic programming guide a schedule change in a first media program being recorded;
detecting a contention between the schedule change in the first media program and a scheduled recording of a second media program;
transmitting a notice to a communication device of a subscriber;
receiving a proposed resolution to said contention; and
adjusting the recording schedule of at least one among the first and second media programs according to said proposed resolution.

2. The storage medium of claim 1, comprising computer instructions for requesting presence information associated with the subscriber.

3. The storage medium of claim 2, comprising computer instructions for:
receiving presence information; and
selecting the communication device of the subscriber according to said presence information.

4. The storage medium of claim 1, comprising computer instructions for:
determining a resolution for the detected contention; and
transmitting the resolution to the communication device of the subscriber.

5. The storage medium of claim 4, comprising computer instructions for receiving one among an acceptance, a rejection, and a counterproposal of the resolution.

6. The storage medium of claim 4, wherein the proposed resolution is received from the subscriber by way of the communication device, and wherein said proposed resolution corresponds to an acceptance of the resolution transmitted to the communication device.

7. The storage medium of claim 1, comprising computer instructions for:
transmitting to a communication system supplying the first and second media programs a request for a copy of at least a portion of the second media program; and
receiving from the communication system at least the portion of the second media program.

8. The storage medium of claim 7, wherein the proposed resolution comprises receiving at least the portion of the second media program from the communication system.

9. The storage medium of claim 1, wherein the first and second media programs are supplied by at least one among an Internet Protocol Television (IPTV) communication system, a satellite TV communication system, and a cable TV communication system.

10. A media content processor, comprising a controller to detect a recording conflict between a schedule change of a first media program and a scheduled recording of a second media program.

11. The media content processor of claim 10, wherein the controller is adapted to determine a resolution for the recording conflict.

12. The media content processor of claim 10, wherein the controller is adapted to:
request presence information associated with a subscriber of the media content processor;
select a communication device of the subscriber according to the presence information; and
transmit to the communication device a notice associated with the recording conflict.

13. The media content processor of claim 12, wherein the controller is adapted to:
determine a proposed resolution for the recording conflict; and
transmit the proposed resolution in the notice.

14. The media content processor of claim 13, wherein the controller is adapted to receive one among an acceptance, a rejection, and a counterproposal of the proposed resolution.

15. The media content processor of claim 10, wherein the controller is adapted to:
transmit to a communication system supplying the first and second media programs a request for a copy of at least a portion of the second media program; and
receive from the communication system at least the portion of the second media program.

16. The media content processor of claim 15, wherein the communication system charges the subscriber a fee for transmitting at least the portion of the second media program.

17. The media content processor of claim 10, wherein the first and second media programs are supplied by at least one among an Internet Protocol Television (IPTV) communication system, a satellite TV communication system, and a cable TV communication system, wherein the media content processor corresponds to one among a set-top box (STB) receiver, and a digital video recorder (DVR), and wherein the controller is adapted to detect the schedule change of the first media program from programming information in at least a portion of an updated electronic programming guide.

18. A computer-readable storage medium of a portal, comprising computer instructions for establishing communications with a media content processor and a communication device of a subscriber of the media content processor to resolve a recording conflict between a schedule change of a first media program and a scheduled recording by the media content processor of a second media program.

19. The storage medium of claim 18, wherein the media content processor presents the communication device with one or more options to resolve the recording conflict.

20. The storage medium of claim 19, wherein the media content processor resolves the recording conflict according to a selection of the one or more resolution options received from the communication device.

21. The storage medium of claim 18, wherein the first and second media programs are supplied by at least one among an Internet Protocol Television (IPTV) communication system, a satellite TV communication system, and a cable TV communication system, and wherein the media content processor corresponds to one among a set-top box (STB) receiver, and a digital video recorder (DVR).

22. A communication device, comprising a controller to receive from a media content processor a notice associated with a recording conflict between a schedule change of a first media program and a scheduled recording by the media content processor of a second media program.

23. The communication device of claim 22, wherein the controller is adapted to detect in the notice a proposed resolution to the recording conflict.

24. The communication device of claim 23, wherein the controller is adapted to transmit one among an acceptance, a rejection, and a counterproposal of the proposed resolution.

25. The communication device of claim 22, wherein the first and second media programs are supplied by at least one among an Internet Protocol Television (IPTV) communication system, a satellite TV communication system, and a cable TV communication system, and wherein the media content processor detects the schedule change of the first media program from programming information in at least a portion of an updated electronic programming guide.

26. The communication device of claim 22, wherein the notice comprises one or more selectable Internet links with one or more instructions for directing the media content processor to act on a proposed resolution to the recording conflict.

27. The communication device of claim 26, wherein the one or more selectable Internet links comprises a corresponding one or more Uniform Resource Identifiers (URIs) with the one or more instructions for directing the media content processor.

28. The communication device of 27, wherein the one or more URIs comprises one among a Session Initiation Protocol URI (SIP URI) and a Uniform Resource locator (URL).

29. The communication device of claim 26, wherein the controller is adapted to present the one or more selectable Internet links as a corresponding one or more selectable graphical user interface (GUI) elements.
